(19) United States
(12) Patent Application Publication
(10) Pub. No.: US 2023/0032360 A1
(43) Pub. Date: Feb. 2, 2023

(54) SAFETY TRANSITION LADDER

(71) Applicant: Inter-Rail Transport, Inc., Centreville, MD (US)

(72) Inventor: James E. HANDLIN, Hallsville, TX (US)

(21) Appl. No.: 17/879,199

(22) Filed: Aug. 2, 2022

Related U.S. Application Data
(60) Provisional application No. 63/228,554, filed on Aug. 2, 2021.

(51) Int. Cl. B61D 49/00; B61D 15/00

(52) U.S. Cl. CPC B61D 49/00; B61D 15/00

(57) ABSTRACT

A safety transition ladder, including a fall prevention enclosure that includes a ladder enclosure section and a platform enclosure section, wherein the platform enclosure section includes a plurality of platforms that are accessible from the ladder enclosure section and an opening of a railcar, and a plurality of connectors that are configured to attach the safety transition ladder to a ladder of the railcar.

### PRIORITY

This application is a non-provisional application that claims the benefit of U.S. Provisional Application No. 63/228,554, filed on Aug. 2, 2021, the contents of which is herein incorporated by reference in their entirety.

### BACKGROUND OF THE INVENTION

### Field of the Invention

The present invention generally relates to a railroad safety device, and more particularly, toward a safety transition ladder.

### Discussion of the Related Art

In the railroad industry, multi-level railcars are frequently used to maximize the use of storage space within the railcar. For example, a bi-level railcar typically includes a lower level and an upper level. In another example, a tri-level railcar has a middle level disposed between the lower level and the upper level.

Multi-level railcars are often used to transport large goods, such as automobiles, sports utility vehicles (SUVs), trucks, mini-vans, etc. Each railcar typically has a maximum load capacity of 10 to 15 vehicles depending on the length and number of levels of the railcar. Products such as larger tractors, motor homes, and military vehicles are transported on uni-level flat cars.

FIG. 1 illustrates a multi-level railcar 100 according to the related art. As shown in FIG. 1, conventional multi-level railcars include ladders 121, 122 to assist users entering and exiting from the multi-level railcar. The example railcar 100 is a tri-level railcar configured to transport a plurality of automobiles 181.

A challenge when loading and unloading such railcars or performing maintenance on the railcars is the risk of users falling out of the end of the railcar, thereby injuring themselves. Users fall either accessing ladders 121, 122 from the rear or front opening of the railcar, accessing the rear or front opening of the railcar from ladders 121, 122, or falling from ladders 121, 122. Hundreds, if not thousands of such falls occur each year. A variety of systems for securing goods and/or for safety are known, such as those disclosed in U.S. Pat. Nos. 8,568,071; 7,175,378; 7,014,053; 6,948,896; 6,758,306; 6,186,274; 5,452,973; 4,215,895; 3,695,698; 3,527,319; and 276,053; as well as U.S. Patent Publication No. 20080131226. In addition, users are trained to avoid such injuries. For example, training techniques such as using three points of contact while climbing are used.

Known safety systems and techniques suffer from one or more disadvantages that makes them non-optimum for use in railcars, such as inadequate safety, difficulty in use, or interfering with entering into and exiting from the railcar. Accordingly, there is a need for a better safety system for railcars.

### SUMMARY OF THE INVENTION

Accordingly, the present invention is directed to a safety transition ladder that substantially obviates one or more problems due to limitations and disadvantages of the related art. In particular, the embodiments of the present invention provide a safety transition ladder that reduces the number of falls from railcars, and reduces user injury caused by falls from railcars.

Features and advantages of the invention are set forth in the description that follows, or will be apparent from the description, or may be learned by practice of the invention.

To achieve these and other advantages and in accordance with the purpose of the present invention, as embodied and broadly described, the safety transition ladder includes a fall prevention enclosure that includes a ladder enclosure section and a platform enclosure section, wherein the platform enclosure section includes a plurality of platforms that are accessible from the ladder enclosure section and an opening of a railcar, and a plurality of connectors that are configured to attach the safety transition ladder to a ladder of the railcar.

In other aspects, the fall prevention enclosure includes a plurality of railings; each of the plurality of platforms corresponds to a level of a railcar; each of the plurality of platforms corresponds to a level of a bi-level railcar; each of the plurality of platforms corresponds to a level of a tri-level railcar; and a height level of each of the plurality of platforms is adjustable.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates a multi-level railcar according to the related art.

FIG. 2 is a perspective view of a safety transition ladder according to an example embodiment of the present invention.

FIG. 3 is a right-side view of the safety transition ladder according to an example embodiment of the present invention.

FIGS. 4A and 4B separately, and in combination, illustrate ingress to and egress from a multi-level railcar according to an example embodiment of the present invention.

### DETAILED DESCRIPTION OF THE INVENTION

Reference will now be made in detail to the embodiments of the present invention, examples of which are illustrated in the accompanying drawings. Wherever possible, like reference numbers will be used for like elements.

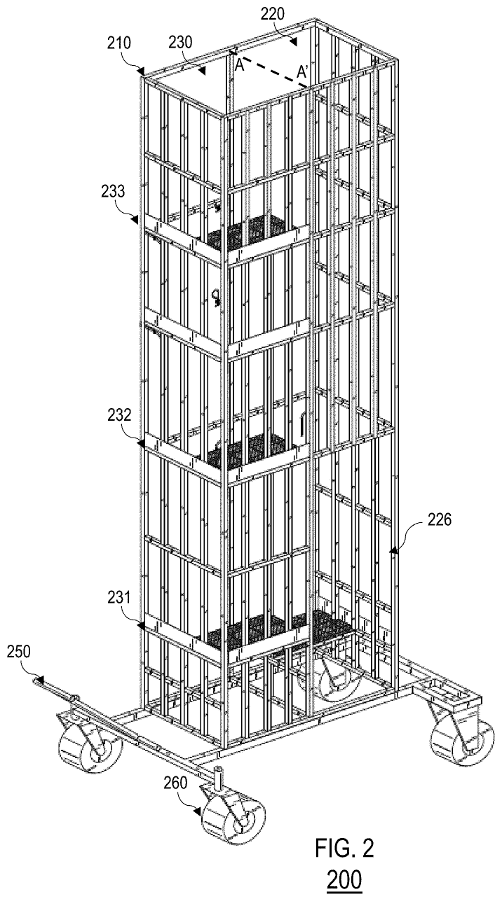

FIG. 2 is a perspective view of a safety transition ladder 200 according to an example embodiment of the present invention.

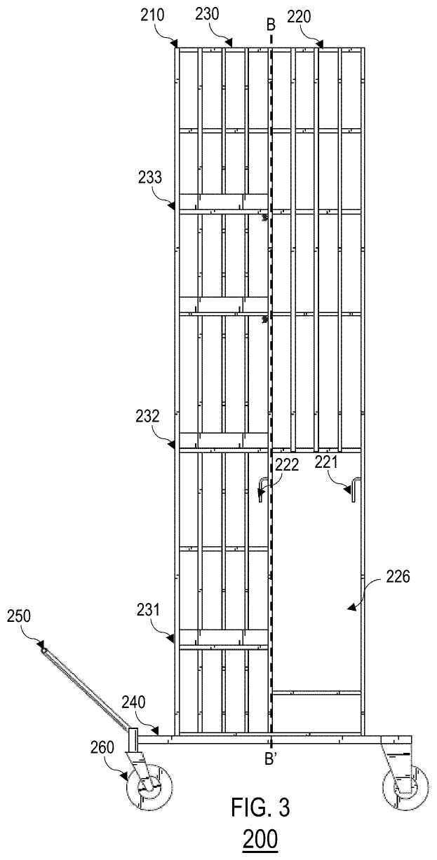

As shown in FIG. 2, safety transition ladder 200 includes a fall prevention enclosure 210 that includes two sections, namely a ladder enclosure section 220 and a platform enclosure section 230, the two sections being divided along dashed line A-A′ in a vertical direction (i.e., dashed line B-B′ of FIG. 3). Safety transition ladder 200 further includes base 240 that is physically joined to and configured to physically support fall prevention enclosure 210. Base 240 includes a steering unit 250 and a plurality of wheel assemblies 260.

Fall prevention enclosure 210, including each of ladder enclosure section 220 and platform enclosure section 230, includes a plurality of railings to provide an enclosure around a user in either of the sections. The plurality of railings are configured to prevent a user from falling to the ground, and/or limit the direction of falls to vertical falls in ladder enclosure section 220. A plurality of openings, such as opening 226, enable a user to safely enter or exit safety transition ladder 200.

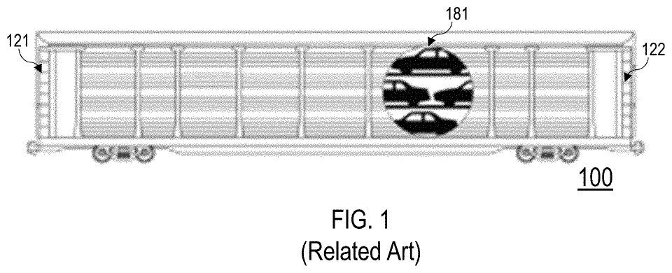

Ladder enclosure section 220 is physically coupled onto a railcar ladder (e.g., ladder 121 of FIG. 1) using one or more connectors (e.g., hook connectors 221, 222 of FIG. 3). From ladder enclosure section 220 or the opening of a railcar, the user may access one or more enclosed platforms 231, 232, 233 in platform enclosure section 230. The height or level of each of the one or more enclosed platforms corresponding to a level of the railcar. In an example tri-level configuration, platform 231 may correspond to a lower level, platform 232 may correspond to a middle level, and platform 233 may correspond to an upper level. The number, and height or level, of each enclosed platform may be adjusted to match the railcar. For example, each of enclosed platforms may be configured to clip onto fall prevention enclosure 210 using one or more connectors, such as hook, screw/bolt, track, tongue/groove, etc. As readily understood by one of ordinary skill in the art, numerous configurations are possible.

The example embodiment depicted in FIG. 2 further includes a plurality of wheel assemblies 260. In this example configuration, four wheels assemblies 260 are coupled to base 240; however, numerous wheel mount configurations are feasible. A variety of wheel types may be used. Example wheel types include standard, orientable, multi-directional, and omni-directional wheels. As readily understood by one of ordinary skill in the art, numerous configurations are possible. Coupled to base 240 is steering unit 250 (e.g., a steering rail) that is used to guide the movement of safety transition ladder 200, such as moving safety transition ladder 200 toward and away from the railcar.

Safety transition ladder 200, and the components thereof, can be formed from various materials including metals and/or durable plastics. In some instances, lightweight metals, such as Aluminum, may be used.

FIG. 3 is a right-side view of the safety transition ladder 200 according to an example embodiment of the present invention.

As shown in FIG. 3, safety transition ladder 200 includes a fall prevention enclosure 210 that includes two sections, namely a ladder enclosure section 220 and a platform enclosure section 230, the two sections being divided along dashed line B-B′ in the vertical direction (and dashed line A-A′ in a traverse direction, as shown in FIG. 1). Safety transition ladder 200 further includes base 240 that is physically joined to and configured to physically support fall prevention enclosure 210. Base 240 includes a steering unit 250 and a plurality of wheel assemblies 260.

Fall prevention enclosure 210, including each of ladder enclosure section 220 and platform enclosure section 230, includes a plurality of railings to provide an enclosure around a user in either of the sections. The plurality of railings are configured to prevent a user from falling to the ground, and/or limit the direction of falls to vertical falls in ladder enclosure section 220. A plurality of openings, such as opening 226, enable a user to safely enter or exit safety transition ladder 200.

Ladder enclosure section 220 is physically coupled onto a railcar ladder (e.g., ladder 121 of FIG. 1) using one or more connectors, such as hook connectors 221, 222. From ladder enclosure section 220 or the opening of a railcar, the user may access one or more enclosed platforms 231, 232, 233 in platform enclosure section 230. The height or level of each of the one or more enclosed platforms corresponding to a level of the railcar. In an example tri-level configuration, platform 231 may correspond to a lower level, platform 232 may correspond to a middle level, and platform 233 may correspond to an upper level. The number, and height or level, of each enclosed platform may be adjusted to match the railcar. For example, each of enclosed platforms may be configured to clip onto fall prevention enclosure 210 using one or more connectors, such as hook, screw/bolt, track, tongue/groove, etc. As readily understood by one of ordinary skill in the art, numerous configurations are possible.

The example embodiment depicted in FIG. 2 further includes a plurality of wheel assemblies 260. In this example configuration, four wheels assemblies 260 are coupled to base 240; however, numerous wheel mount configurations are feasible. A variety of wheel types may be used. Example wheel types include standard, orientable, multi-directional, and omni-directional wheels. As readily understood by one of ordinary skill in the art, numerous configurations are possible. Coupled to base 240 is steering unit 250 (e.g., a steering rail) that is used to guide the movement of safety transition ladder 200, such as moving safety transition ladder 200 toward and away from the railcar.

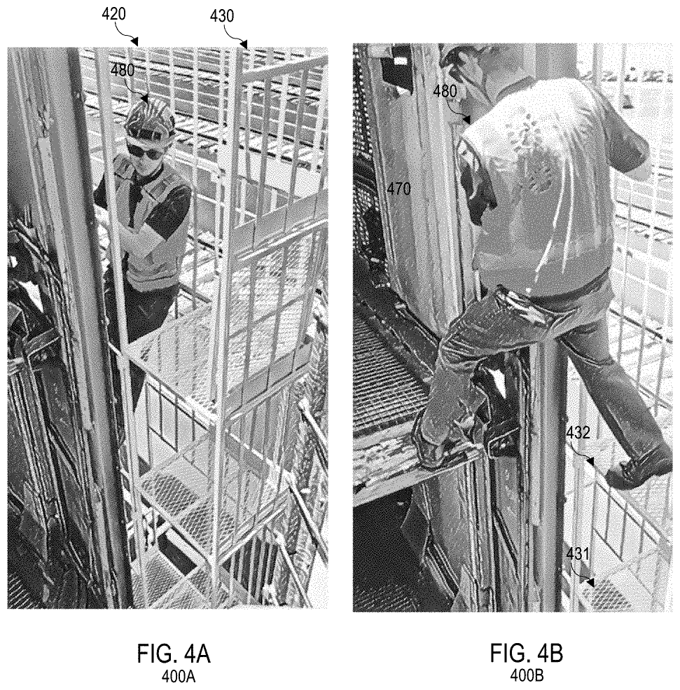

FIGS. 4A and 4B separately, and in combination, illustrate ingress to and egress from a multi-level railcar according to an example embodiment of the present invention.

As shown in each of FIGS. 4A and 4B, safety transition ladder 400A, 400B includes a fall prevention enclosure that includes two sections, namely ladder enclosure section 420 and platform enclosure section 430. The user can easily access the opening of the rail car using the platform 432. In addition, safety transition ladder 400A, 400B enables multiple users to enter or exit the rail car. For example, when users are exiting the railcar, one user may go down the ladder while a second user waits to go down the ladder while remaining on the platform.

As described herein, a device, which couples to existing railcar ladders and offers a fall prevention enclosure and transition platforms at each of the railcar levels (e.g., bi-level or tri-level) for safe entry and exiting of railcars, is provided. The fall prevention enclosure provides a safety backstop that prevents falling from railcar ladders. Also provided is one or more platforms for each level making transitioning in and out of railcars much safer. Accordingly, falls and injuries will be greatly reduced by utilizing the embodiments of the invention as described herein.

It will be apparent to those skilled in the art that various modifications and variations can be made in the railroad safety device of the present invention without departing from the spirit or scope of the invention. Thus, it is intended that the present invention cover the modifications and variations of this invention provided they come within the scope of the appended claims and their equivalents.

What is claimed is:

1. A safety transition ladder, comprising:
a fall prevention enclosure that includes a ladder enclosure section and a platform enclosure section, wherein the platform enclosure section includes a plurality of platforms that are accessible from the ladder enclosure section and an opening of a railcar; and
a plurality of connectors that are configured to attach the safety transition ladder to a ladder of the railcar.

2. The safety transition ladder according to claim 1, wherein the fall prevention enclosure includes a plurality of railings.

3. The safety transition ladder according to claim 1, wherein each of the plurality of platforms corresponds to a level of a railcar.

4. The safety transition ladder according to claim 1, wherein each of the plurality of platforms corresponds to a level of a bi-level railcar.

5. The safety transition ladder according to claim 1, wherein each of the plurality of platforms corresponds to a level of a tri-level railcar.

6. The safety transition ladder according to claim 1, wherein a height level of each of the plurality of platforms is adjustable.
